(19) United States
(12) Patent Application Publication
(10) Pub. No.: US 2025/0209176 A1
(43) Pub. Date: Jun. 26, 2025

(54) SOFTWARE VULNERABILITY DETECTION

(71) Applicant: AMERICAN EXPRESS TRAVEL RELATED SERVICES COMPANY, INC., New York, NY (US)

(72) Inventor: Hiranmayi PALANKI, Tampa, FL (US)

(73) Assignee: AMERICAN EXPRESS TRAVEL RELATED SERVICES COMPANY, INC., New York, NY (US)

(21) Appl. No.: 18/390,254

(22) Filed: Dec. 20, 2023

(51) Int. Cl. G06F 21/57

(52) U.S. Cl. CPC G06F 21/577; G06F 2221/033

(57) ABSTRACT

Disclosed herein are system, method, and computer program product embodiments for using a combination of large language models (LLMs), generative adversarial networks (GANs), and/or quantum GANs to detect software vulnerabilities. A vulnerability scanning system receives source code. The vulnerability scanning system generates quantum source code by transforming the source code into a quantum computing data format. The vulnerability scanning system determines that the source code includes a potential vulnerability by applying a quantum generative adversarial network (QGAN) model to the quantum source code. In response to determining that the source code includes a potential vulnerability, the vulnerability scanning system determines that the source code includes code corresponding to a vulnerability by applying a large language model to the source code. The vulnerability scanning system may then apply a vulnerability policy to the source code to mitigate the vulnerability and/or to prevent its spread.

### BACKGROUND

### Field

This field is generally related to increasing security by using large language models (LLM) and generative adversarial networks (GAN) to detect software vulnerabilities.

### Related Art

Enterprise computing systems are often the targets of cyber attacks. These attacks may originate from outside entities planting malware on enterprise networks. Additionally, developers working for the enterprise may unknowingly introduce vulnerabilities through defective software. Typically, detection of software vulnerabilities requires use of multiple, distinct tools to scan source code, applications, and data packets entering a secure network. Reliance on disparate tools for software vulnerability detection, however, is costly, resource intensive, and exposes the enterprise to security issues or lack of coverage that may develop between the tools.

### BRIEF SUMMARY

Disclosed herein are system, apparatus, device, method and/or computer program product embodiments, and/or combinations and sub-combinations thereof, for increasing security by using large language models (LLMs), generative adversarial networks (GANs), and/or quantum GANs to detect software vulnerabilities. A vulnerability scanning system may be used to detect and/or mitigate the effects of potential software vulnerabilities. Software vulnerabilities may be characteristics of source code or applications that may be exploited by a malicious actor. The vulnerability scanning system may use large language models (LLMs), generative adversarial networks (GANs), and/or quantum GANs to detect software vulnerabilities. LLMs may detect source code features to detect software vulnerabilities. GANs may be used to implement generator and discriminator components. The generator may create example source code used to train the discriminator. The discriminator may be trained to detect whether the source code was created by the generator and/or was live source code committed to a repository. The generator and/or the discriminator may be trained and/or re-trained to more accurately produce test source code and/or to evaluate the source of source code creation.

The vulnerability scanning system may also use quantum computers and/or quantum computing techniques to detect vulnerabilities. For example, LLM and/or GAN models may be implemented using quantum computing techniques. The LLM and/or the quantum GAN (QGAN) may be used to detect source code vulnerabilities. For example, in an embodiment, a vulnerability scanning system may receive source code. To utilize the quantum computing techniques, the vulnerability scanning system may generate quantum source code by transforming the source code into a quantum computing data format. The vulnerability scanning system may then determine that the source includes a potential vulnerability by applying a quantum GAN model to the quantum source code. In response to determining that the source code includes a potential vulnerability, the vulnerability scanning system may determine that the source code includes code corresponding to a vulnerability by applying a LLM to the source code. In response to determining that the source code includes code corresponding to a vulnerability, the vulnerability scanning system may apply a vulnerability policy to the source code based on a vulnerability type associated with the vulnerability.

### BRIEF DESCRIPTION OF THE DRAWINGS

The accompanying drawings are incorporated herein and form a part of the specification.

FIG. 1A depicts a block diagram of a source code vulnerability scanning environment, according to some embodiments.

FIG. 1B depicts a block diagram of a source code vulnerability scanning environment with a quantum system external to a vulnerability scanning system, according to some embodiments.

FIG. 1C depicts a block diagram of a source code vulnerability scanning environment with a vulnerability scanning system and a quantum system configured to perform vulnerability scanning, according to some embodiments.

FIG. 2 depicts a block diagram of a vulnerability scanner, according to some embodiments.

FIG. 3 depicts a flowchart illustrating a method for detecting and managing source code vulnerabilities, according to some embodiments.

FIG. 4 depicts a flowchart illustrating a method for determining a vulnerability type, according to some embodiments.

FIG. 5 depicts a flowchart illustrating a method for determining whether source code includes a vulnerability using a quantum computing system, according to some embodiments.

FIG. 6 depicts a flowchart illustrating a method for training a GAN model, according to some embodiments.

FIG. 7 depicts a flowchart illustrating a method for applying a quantum analysis to a payload, according to some embodiments.

FIG. 8 depicts an example vulnerability score report, according to some embodiments.

FIG. 9 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for using large language models (LLMs), generative adversarial networks (GANs), and/or quantum GANs to detect software vulnerabilities. Upon detecting a potential software vulnerability, a policy may be applied to mitigate damage and/or exposure to the potential software vulnerability.

In some embodiments, a vulnerability scanning system may be used to detect and/or mitigate the effects of potential software vulnerabilities. Software vulnerabilities may be characteristics of source code or applications that may be exploited by a malicious actor. For example, a software vulnerability may refer to a function within an application that is vulnerable to SQL injection.

The vulnerability scanning system may use large language models (LLMs), generative adversarial networks (GANs), and/or quantum GANs to detect software vulnerabilities. LLMs may be machine learning models that are trained using large datasets. The LLMs may be capable of capturing hundreds of millions of parameters. Due to their size and ability to identify complex relationships, LLMs may be used for natural language processing to perform tasks such as translation and function as chatbots. The vulnerability scanning system may also use LLMs to model complex data for software vulnerability detection. For example, vulnerability scanning system may apply an LLM to source code. Source code and human language share similarities. For example, both utilize temporal relationships to determine context and/or meaning of syntax. Similar to sentences in a written paragraph of prose, the code written at the beginning of a function may be relevant and/or impact syntax elsewhere in the function, such as at the end. Additionally, a function and a paragraph may include certain parts that are more critical and/or indicate a greater syntactic and/or semantic impact than others. The vulnerability scanning system described herein may use LLMs to detect such features and to detect software vulnerabilities. For example, the vulnerability scanning system may apply LLM techniques used to understand language to understand source code as well.

The vulnerability scanning system may also use GANs to aid in detecting software vulnerabilities. GANs may be machine learning models and/or may include two components: a generator and a discriminator. The generator and discriminator may be designed to optimize each other. The generator is optimized to generate data samples that appear as if they came from a real source. For example, if a GAN is designed for facial detection, the generator may produce images of faces, with the images becoming increasingly realistic as the generator receives feedback from the discriminator. The discriminator, in turn, is optimized to detect whether an input was created by the generator. Over time, the discriminator may become more effective at reducing the number of false positives based on its ability to determine whether an input is real or generated.

With regard to the vulnerability scanning system and vulnerability detection, the generator may produce realistic code source. Depending on the situation, the examples may contain actual vulnerabilities, or they may appear to contain vulnerabilities (e.g., false positives). The generator may create examples with actual vulnerabilities in order to build a training data set that may be used by the LLM. The generator may also create false positive vulnerabilities in order to train the discriminator. The discriminator may be used to identify whether the source code came from the generator. This may be used in an enterprise system to reduce the number of false positive samples that are discarded or inspected. Additionally, as the generator becomes more proficient at creating realistic data, the generated data may be used to construct a robust training set. For example, if a training set is built using captured data, the training set may be skewed if the data set does not include equal and/or balanced numbers of each data type. In this case, the resulting models may have a bias toward detecting the more prevalent data types. A generator may alleviate this issue by creating realistic training data samples with a uniform data type distribution. This training set may be used to train the discriminator and/or the LLM discussed herein. An enterprise computing system may also use quantum computers to increase the effectiveness of vulnerability detection. Both the LLM and GAN models may be employed on quantum computers to increase the performance of the vulnerability scanning system.

Various embodiments of these features will now be discussed with respect to the corresponding figures.

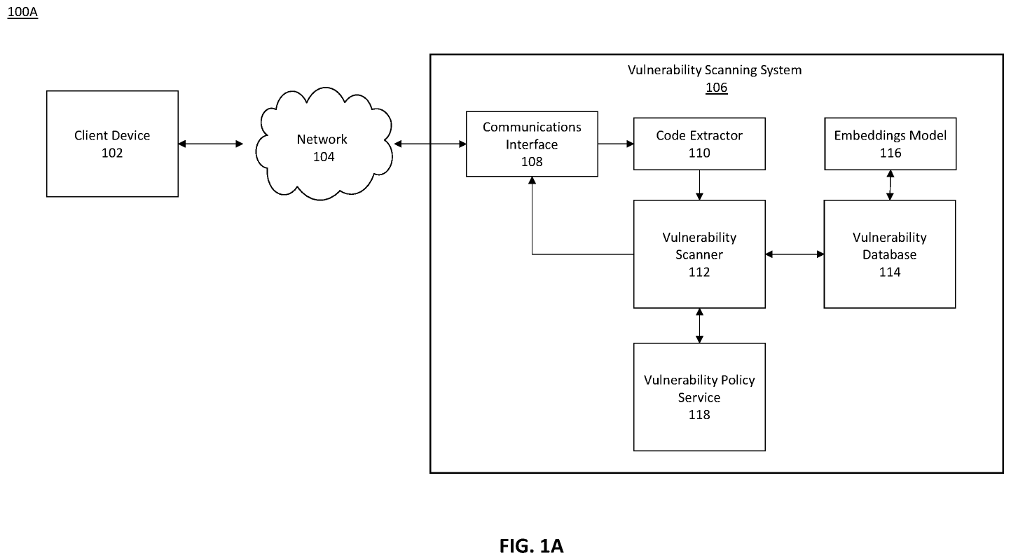

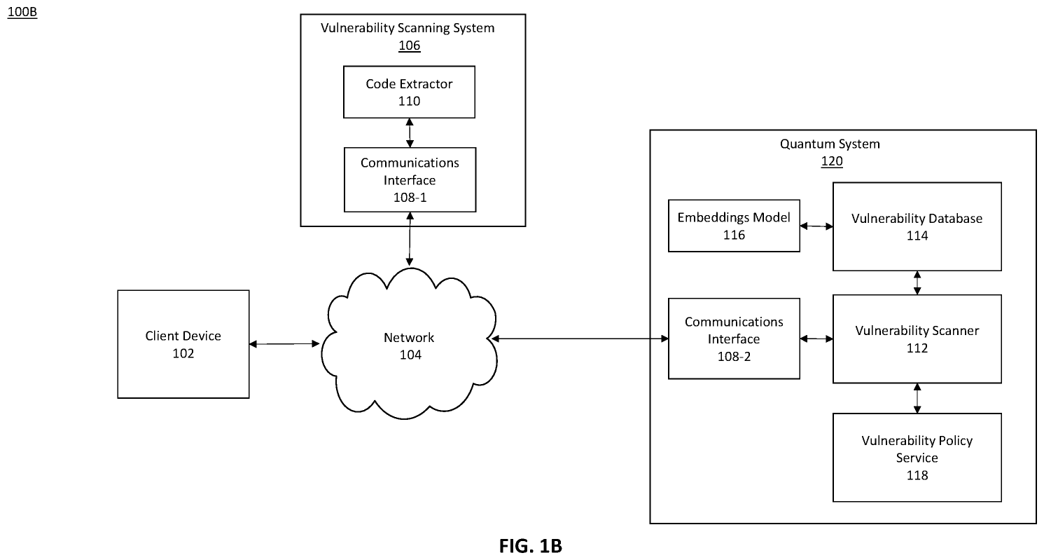

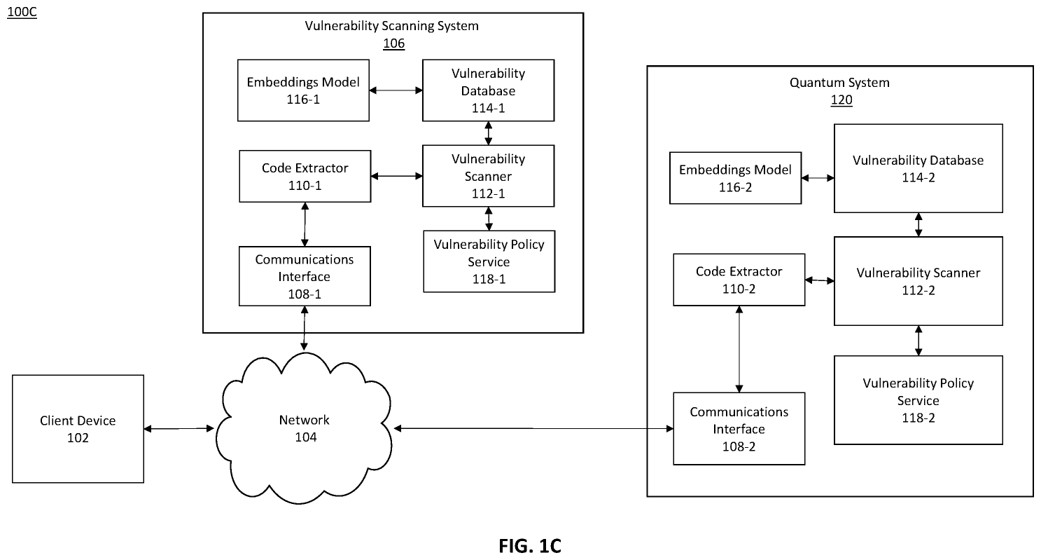

FIG. 1A depicts a block diagram of a source code vulnerability scanning environment 100A, according to some embodiments. Environment 100A may include client device 102, network 104, vulnerability scanning system 106, communications interface 108, code extractor 110, vulnerability scanner 112, vulnerability database 114, embeddings model 116, and vulnerability policy service 118.

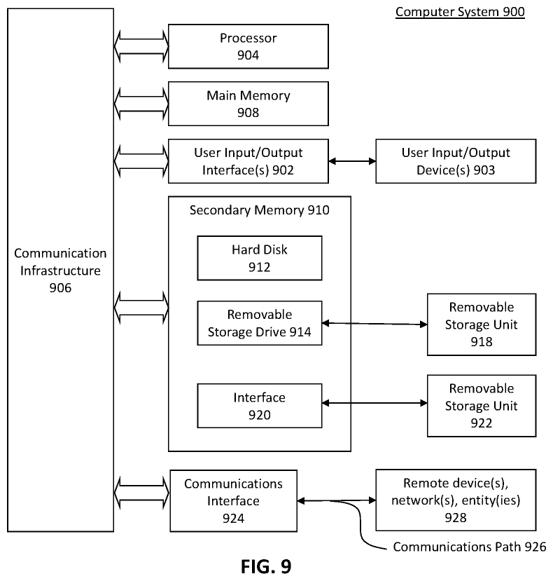

Vulnerability scanning system 106 may be implemented using one or more servers and/or databases. For example, vulnerability scanning system 106 may be implemented as part of an enterprise computing system and/or a cloud computing system. In some embodiments, vulnerability scanning system 106 may be implemented using a computer system such as computer system 900 described with reference to FIG. 9. In some embodiments, vulnerability scanning system 106 may be implemented using a computing device such as a desktop workstation, laptop or notebook computer, netbook, tablet, smart phone, and/or other computing device. In some embodiments, vulnerability scanning system 106 may be and/or include a quantum computing system. The quantum computing system may be configured to use qubits to store information. In some embodiments, the quantum computing system may contain one or more quantum logic gates used to implement one or more quantum circuits.

Client device 102 may be a computer system such as computer system 900 described with reference to FIG. 9. For example, client device 102 may be implemented using one or more servers and/or databases. In some embodiments, client device 102 may be implemented using a computing device such as a desktop workstation, laptop or notebook computer, netbook, tablet, smart phone, and/or other computing device. In some embodiments, client device 102 may be implemented as an application in an enterprise computing system.

In some embodiments, client device 102 resides within a secure network, such as an enterprise network. Client device 102 may be terminal used by a software developer and/or other system that produces and/or communicates a software application programming, source code, or executable code. The application, source code, or executable code may be packaged as part of a payload. For example, client device 102 may be used by a developer to commit source code to a network repository. As another example, client device 102 may have downloaded an application for use on network 104. Client device 102 may communicate with vulnerability scanning system 106 via network 104.

Network 104 may be may be any type of computer or telecommunications network capable of communicating data, for example, a local area network, a wide-area network (e.g., the Internet), or any combination thereof. The network may include wired and/or wireless segments. In some embodiments, vulnerability scanning system 106 may represent one or more servers connected via a network, such as network 104.

Communications interface 108 may be configured to communicate with client device 102 via network 104. Communications interface 108 may comprise any suitable network interface capable of transmitting and receiving data, such as, for example a modem, an Ethernet card, a communications port, or the like. Communications interface 108 may be able to transmit data using any wireless transmission standard such as, for example, Wi-Fi, Bluetooth, cellular, or any other suitable wireless transmission. Communications interface 108 may also be in communication with code extractor 110.

Code extractor 110 may identify source code or executable code to be scanned for vulnerabilities. Code extractor 110 may inspect payloads from network 104 and identify source code or executable code. This may include code provided by client device 102. Code extractor 110 may look at file types to determine whether source code is present. For example, a file having a type “.py” may indicate that the file contains Python source code. Code extractor 110 may identify a file extension to identify source code. Code extractor 110 may also open files and/or inspect file contents to identify source code. This inspection may involve using regular expressions, machine learning, artificial intelligence, and/or other analysis to identify source code. Once code extractor 110 identifies a payload with source or executable code, it may remove the source or executable code, package it, and send the packaged payload to vulnerability scanner 112. Code extractor 110 may communicate the payload to vulnerability scanner 112 via a network connection. As another example, code extractor 110 may place the payload on a queue that vulnerability scanner 112 reads from.

Once vulnerability scanner 112 receives the payload, it may analyze the source code within the payload to identify any vulnerabilities. For example, vulnerability scanner 112 may identify portions of code that may correspond to a vulnerability. To identify this code, vulnerability scanner 112 may contain an LLM that is trained to detect software vulnerabilities. Vulnerability scanner 112 may be configured to transform the source code so that it may be analyzed. For example, vulnerability scanner 112 may tokenize or encode the source code into a numerical format. As another example, vulnerability scanner 112 may encode or transform the source code into a vector (e.g., a source code vector) or matrix (e.g., a source code matrix.) Vulnerability scanner 112 may be trained using data stored by vulnerability database 114.

Vulnerability database 114 may be used to store vector representations of vulnerability types. For example, vulnerability database 114 may contain entries for SQL injection, command cross-site scripting, remote code execution, and command injection. The entries in vulnerability database 114 may include vector representations of source code corresponding to such vulnerabilities. Vulnerability database 114 may contain one or more examples for each vulnerability type. Vulnerability database 114 may also contain duplicates of the same vulnerability, implemented across different programming languages. Vulnerability database 114 may be stored on a memory storage device. Vulnerability database 114 may maintain a database configuration for storing data. For example, vulnerability database 114 may be organized into key-value pairs, where the vulnerability type is the key and its corresponding vector representation is the value. Vulnerability database 114 may receive vector representations corresponding to vulnerability types from embeddings model 116.

Embeddings model 116 may be used to generate vector representations of each vulnerability type. Storing the vector representations of each vulnerability type may allow received source code to be quickly compared against each stored vector representation. For example, analyzing the source code in a programming language syntax may require converting the text to the numerical vector representation for each comparison. This process may be inefficient due to an increased amount of the time to inspect each payload. By storing the numerical vector representation of each vulnerability type, the comparisons may be performed much faster. For example, this comparison may be performed by calculating the cosine similarity between the source code vector and the stored vector representation of each vulnerability type. As another example, a nearest neighbor search may be performed.

Embeddings model 116 may also add new vulnerability type vector representations to vulnerability database 114. For example, if a new vulnerability is discovered, embeddings model 116 may create a vector representation of the vulnerability and add it to vulnerability database 114.

When vulnerability database 114 is updated, vulnerability scanner 112 may be trained on the updated vulnerability database 114. In some embodiments, the LLM at vulnerability scanner 112 may be trained using vulnerability database 114. This allows for vulnerability scanner 112 to detect new and updated vulnerability types that may be received by communications interface 108. Vulnerability scanner 112, in addition to generating its own vulnerability predictions, may also query vulnerability database 114 to determine the similarity between received source code and each entry in vulnerability database 114.

This query feature may be turned on or off, based on various factors. For example, if network 104 is experiencing high latency, the query feature may be disabled so that the payloads are processed faster. In some embodiments, the query feature may be utilized based on vulnerability scanner 112's prediction. For example, if vulnerability scanner 112's prediction is between a predefined threshold range (e.g., 50-60%), this may mean that the LLM is “unsure” about whether the source code includes a vulnerability. Therefore, the query feature may be used as an additional layer of security to bolster vulnerability scanner 112's decision. The query feature may also be used in a situation where new vulnerability types have been added to sensitive data database 114, but for certain reasons vulnerability scanner 112 has not yet been trained on that new data. In this instance, vulnerability scanner 112 may consult vulnerability database 114 to determine whether any received source code contains code that corresponds to the new vulnerability types.

Vulnerability scanner 112 may consult vulnerability policy service 118 to determine an action responsive to detecting source code that corresponds to a data vulnerability. Vulnerability policy service 118 may store one or more policies in memory of vulnerability scanning system 106. The policy applied to the source code may be determined by a combination of the identified vulnerability and a vulnerability probability. The vulnerability probability may be a value representing the probability that the source code contains the vulnerability identified by vulnerability scanner 112. In some embodiments, the policy may specify that the source code should be discarded, preventing that source code from traveling to another entity connected to network 104. In some embodiments, the source code may be quarantined for future inspection. In some embodiments, the policy may be communicated to client device 102 so that it can be provided to a user and/or to inform a user of potential security issues in the received source code.

As described herein, vulnerability scanning system 106 may be implemented on, implemented using, and/or include a quantum computing system. In this case, communications interface 108, code extractor 110, vulnerability scanner 112, vulnerability database 114, embeddings model 116, and/or vulnerability policy service 118 may also reside on the quantum computing system. Vulnerability scanner 112 may include an LLM (e.g., a quantum LLM) trained to identify software vulnerabilities. Vulnerability scanner 112 may also include a GAN (e.g., a quantum GAN (QGAN)) to detect and reduce the number of false positive payloads to be inspected. Vulnerability scanner 112 may also query vulnerability database 114 to compare received source code to samples stored at vulnerability database 114. Vulnerability database 114 may also be used to train the quantum LLM and/or quantum GAN at vulnerability scanner 112. By performing the operations of vulnerability scanning system 106 on a quantum computing system, greater performance and accuracy may be achieved.

FIG. 1B depicts a block diagram of a source code vulnerability scanning environment 100B with a quantum system 120 external to a vulnerability scanning system 106, according to some embodiments. In this embodiment, vulnerability scanner 112, vulnerability database 114, and vulnerability policy service 118 may reside on quantum system 120. In this configuration, vulnerability scanning system 106 may be used to receive payloads that include source code for vulnerability scanning. Code extractor 110 may identify and extract the source code components for scanning. This may occur at vulnerability scanning system 106. Vulnerability scanning system 106 may then transmit the extracted source code to quantum system 120 via communications interface 108-1 and/or network 104.

Quantum system 120 may receive the payload via communications interface 108-2. Once received, vulnerability scanner 112 may scan the source code within the payload for any vulnerabilities. For example, vulnerability scanner 112 may identify source code that corresponds to a vulnerability. Similar to environment 100A in FIG. 1A, vulnerability scanner 112, may contain an LLM (e.g., a quantum LLM) trained to identify software vulnerabilities in source code. Vulnerability scanner 112 may also contain a GAN (e.g., a quantum GAN (QGAN)) to detect and reduce the number of false positive payloads to be inspected. Vulnerability scanner 112 may also query vulnerability database 114 to compare received source code to samples stored at vulnerability database 114. Vulnerability database 114 may also be used to train vulnerability scanner 112. By operating vulnerability scanner 112 on quantum system 120, greater performance and accuracy may be achieved.

FIG. 1C depicts a block diagram of a source code vulnerability scanning environment 100C with a vulnerability scanning system 106 and a quantum system 120 configured to perform vulnerability scanning, according to some embodiments. Environment 100C depicts an embodiment where both vulnerability scanning system 106 and quantum system 120 are configured to perform vulnerability scanning. Although only one vulnerability scanning system 106 and one quantum system 120 are depicted, multiple of each system may be operating in parallel. Vulnerability scanning system 106 and quantum system 120 may each include multiple computers arranged to communicate with one another and/or operate in parallel. Leveraging both vulnerability scanning system 106 and quantum system 120 may be beneficial to distribute the workload across multiple machines. For example, vulnerability scanning system 106 may be used to scan payloads that are smaller in size or less complex, whereas quantum system 120 may be used to scan larger payloads.

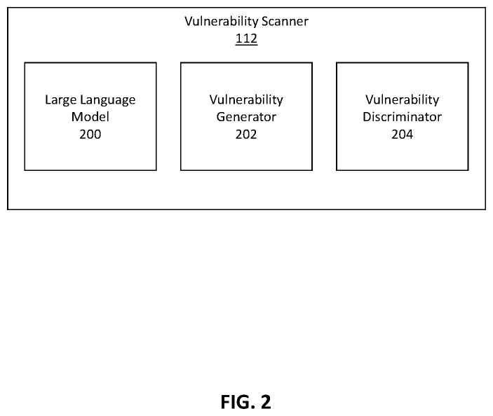

FIG. 2 depicts a block diagram of a vulnerability scanner 112, according to some embodiments. Vulnerability scanner 112 may be similar to vulnerability scanner 112 as described with reference to FIG. 1. Vulnerability scanner 112 may comprise large language model 200, vulnerability generator 202, and/or vulnerability discriminator 204. Large language model 200, vulnerability generator 202, and/or vulnerability discriminator 204 may be machine learning models. In some embodiments, large language model 200, vulnerability generator 202, and/or vulnerability discriminator 204 may be stored as n-dimensional matrices.

Large language model 200 may be a model trained to detect vulnerabilities in source code. For example, large language model 200 may be trained to analyze syntax and/or functions written in source code. Large language model 200 may receive source code as input, convert it to a numerical representation, and then predict whether any software vulnerabilities are present based on trained model weights.

Vulnerability generator 202 may be a model trained and/or optimized to generate source code or executable code examples containing vulnerabilities that appear real. For example, vulnerability generator 202 may be trained to generate source code examples that appear as if they originated from client device 102. Before training, vulnerability generator 202 may be given access to a training data set to pull from. This training data set may include source code examples captured from client device 102. In some embodiments, the initial training data set may contain examples manually created. In some embodiments, vulnerability generator 202 may randomly sample a probability distribution to generate examples. Vulnerability generator 202 may be configured to create samples via prompt engineering. For example, vulnerability generator 202 may create an example in response to the following input: “Create a function written in C with a buffer overflow vulnerability.”

Vulnerability generator 202 may create samples that include software vulnerabilities, or appear to include software vulnerabilities. In some embodiments, using vulnerability generator 202 to create samples that include software vulnerabilities may be useful to build robust sets of training data. If training data sets were constructed only from examples captured from client device 102, then the training data may be limited because it is possible that some vulnerability types would be absent. This training data could be supplemented by manually generating samples containing additional vulnerabilities, but this process may be expensive and/or inefficient. Vulnerability generator 202 may solve this problem by creating data sets that include (1) massive numbers of samples and/or (2) samples comprising many vulnerability types. The training data may be used to train large language model 200.

Vulnerability discriminator 204 may be used to identify and/or screen false positives. False positives may include payloads that appear as if they contain software vulnerabilities, but in fact, do not. An example of a false positive may be a function that accepts user input and is vulnerable to a SQL injection attack, but the lines of code are in fact commented out. Thus, a conventional vulnerability scanner using regular expressions may flag the function as containing a vulnerability that needs to be inspected or discarded. However, since the vulnerability is commented out, further processing may be a waste of computer resources. Optimizing vulnerability discriminator 204 to detect false positives may increase performance of vulnerability scanner 112.

Vulnerability discriminator 204 may be optimized by iteratively training with vulnerability generator 202. In some embodiments, vulnerability generator 202 may be configured to generate source code examples containing false positive vulnerabilities. Vulnerability discriminator 204 may then determine whether the examples are false positives. Vulnerability discriminator 204 may be updated based on whether it correctly identified the false positive examples. Thus, over time, vulnerability discriminator 204 may become more proficient at identifying false positive software vulnerabilities. In some embodiments, this may be used to reduce the number of payloads from client device 102 that need to be inspected because the false positives can be screened by vulnerability discriminator 204.

As described above, vulnerability scanner 112 may be implemented using vulnerability scanning system 106. Vulnerability scanning system 106 and/or vulnerability scanner 112 may be implemented using and/or include a quantum computing system such as quantum system 120.

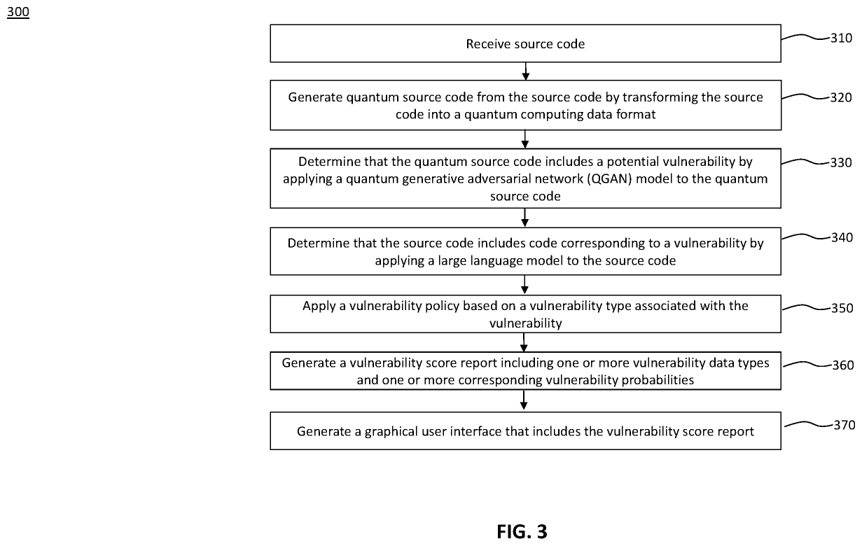

FIG. 3 depicts a flowchart illustrating a method 300 for detecting and managing source code vulnerabilities, according to some embodiments. Method 300 shall be described with reference to FIG. 1A, however, method 300 shall not be limited to that example embodiment.

In an embodiment, vulnerability scanning system 106 may utilize method 300 to determine whether source code includes code corresponding to a vulnerability. The foregoing description will describe an embodiment of the execution of method 300 with respect to vulnerability scanning system 106. While method 300 is described with reference to vulnerability scanning system 106, method 300 may be executed on any computing device, such as, for example, the computer system described with reference to FIG. 9 and/or processing logic that may comprise hardware (e.g., circuitry, dedicated logic, programmable logic, microcode, etc.), software (e.g., instructions executing on a processing device), or a combination thereof. In some embodiments, method 300 and/or portions of method 300 may be executed on a quantum computing system and/or using quantum computing techniques.

It is to be appreciated that not all steps may be needed to perform the disclosure provided herein. Further, some of the steps may be performed simultaneously, or in a different order than shown in FIG. 3.

At 310, vulnerability scanning system 106 receives source code. The source code may be packaged in a payload. In some embodiments, the source code may be executable code or application code. In some embodiments, the payload may be received by communications interface 108 at vulnerability scanning system 106. Communications interface 108 may forward the payload to code extractor 110. Code extractor 110 may extract source code from the payload. In some embodiments, vulnerability scanning system 106 may receive source code when a developer attempts to commit the code to a storage repository. Vulnerability scanning system 106 may determine whether the source code includes code corresponding to a vulnerability prior to committing such code to the repository. If a vulnerability is detected, vulnerability scanning system 106 prevents the code from being committed.

At 320, vulnerability scanning system 106 generates quantum source code from the source code received at 310 by transforming source code into a quantum computing data format. Vulnerability scanning system 106 may format the source code so that it is compatible with a quantum computing system. In some embodiments, code extractor 110 may identify and format the source code components into the quantum computing data format. For example, this may include converting the source code into a qubit representation and/or other quantum information representation.

At 330, vulnerability scanning system 106 determines that the source code includes a potential vulnerability by applying a quantum generative adversarial network (QGAN) model to the quantum source code. Vulnerability scanning system 106 may determine whether one or more source code components include a potential vulnerability. Vulnerability scanning system 106 may make this determination by applying a quantum GAN model. For example, vulnerability scanning system 106 may use vulnerability discriminator 204 at vulnerability scanner 112. The quantum GAN model may be used to reduce the false positive rate by screening out source code that would be flagged for inspection by pattern matching systems, such as regular expressions. For example, a false positive may be a function that reads an input and is susceptible to buffer overflow. However, if the function is in fact commented out, then there is no vulnerability present. Using a GAN model to detect this false positive may reduce the amount of resources vulnerability scanning system 106 consumes inspecting messages.

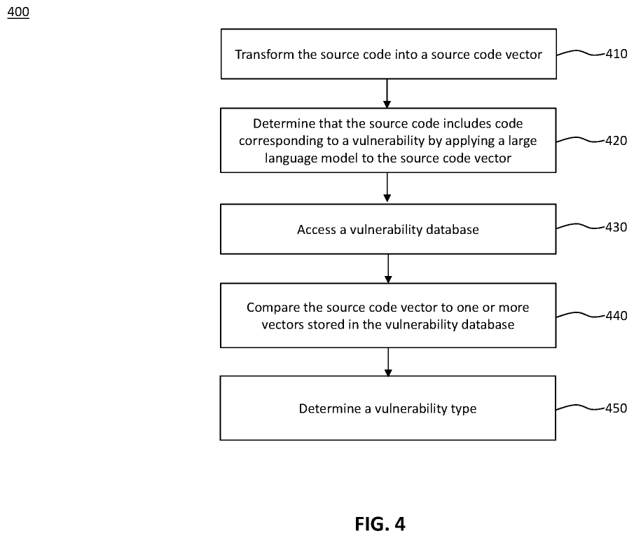

At 340, vulnerability scanning system 106 determines that the source code includes code corresponding to a vulnerability by applying a large language model to the source code. In some embodiments, vulnerability scanning system 106 uses vulnerability scanner 112 to perform the determination. One or more source code components may be applied to large language model 200 to produce a probability score corresponding to the likelihood that a vulnerability is present. For example, a code portion of the source code may correspond to a vulnerability type or vulnerability profile that the LLM is trained to detect. Vulnerability scanning system 106 may determine the vulnerability type of the vulnerability as well. This is further described with reference to FIG. 4.

At 350, a vulnerability scanning system 106 applies a vulnerability policy to the source code based on a vulnerability type associated with the vulnerability. In some embodiments, vulnerability scanner 112 at vulnerability scanning system 106 may apply the policy. Vulnerability scanning system 106 may query a policy application service, such as vulnerability policy service 118, to retrieve the policy. The vulnerability policy may vary based on the vulnerability identified. For example, certain vulnerabilities may be deemed higher risk than others. This may be due to the amount of exposure the vulnerability creates, or it may also be due to the kind of data that is put at risk by the vulnerability. In these instances, vulnerability policy service 118 may supply a policy that shuts down all entities running the code with the identified vulnerability. As another example, the vulnerability policy may specify to discard the payload, preventing transmission of the vulnerable code to other entities. In some embodiments, more analysis of the source code may be required, so vulnerability policy service 118 may supply a policy that saves the payload offline for future inspection.

At 360, vulnerability scanning system 106 generates a vulnerability score report including one or more vulnerability data types and one or more corresponding vulnerability probabilities. The vulnerability score report may be generated once vulnerability scanning system 106 determines the source code includes code corresponding to a vulnerability. The vulnerability score report may list each vulnerability type and LLM 200's corresponding prediction for that type. In embodiments, the prediction may be written as a percentage indicating the probability that the source code includes a vulnerability corresponding to the vulnerability type.

In some embodiments, the vulnerability score report may list each vulnerability type in vulnerability database 114 to which the source code was compared, and the probability that the source code includes the corresponding vulnerability type. For example, the payload may have been compared to four vulnerability types: (1) cross-site scripting; (2) SQL injection; (3) remote code injection; and (4) command injection. Each vulnerability type may have a corresponding probability based on the similarity between the vulnerability type and the source code vector. The probability may be denoted as a percentage (e.g., 90%). In some embodiments, vulnerability scanner 112 may be configured to list only certain vulnerability types, or only vulnerability types with a corresponding probability score greater than a certain percentage. For example, vulnerability types with probability scores greater than 50% may be listed on the vulnerability score report. This may be useful in a situation where there is uncertainty as to whether the payload contains a vulnerability, and so the payload along with the vulnerability score report may be saved for later inspection.

At 370, vulnerability scanning system 106 generates a graphical user interface (GUI) that includes the vulnerability score report. The GUI may allow client device 102 to view and/or display the vulnerability score report. In an embodiment, vulnerability scanning system 106 may cause the GUI to display the vulnerability score report and the source code, so that client device 102 can compare the two. For example, the vulnerability scanning system 106 may highlight, within the GUI, a part of the source code and the corresponding vulnerability type listed in the vulnerability score report. This may be beneficial so that client device 102 may determine what type of vulnerability was included in the source code and remove it.

FIG. 4 depicts a flowchart illustrating a method 400 for determining a vulnerability type, according to some embodiments. Method 400 may provide additional details for 340 as described with reference to FIG. 3. Method 400 shall be described with reference to FIG. 1; however, method 400 is not limited to that example embodiment

In an embodiment, vulnerability scanning system 106 may utilize method 400 to determine a type of vulnerability detected in source code. Vulnerability scanning system 106 may make this determination by applying a transformer model and/or querying a vulnerability database 114. The foregoing description will describe an embodiment of the execution of method 400 with respect to vulnerability scanning system 106 and/or method 300. While method 400 is described with reference to vulnerability scanning system 106, method 400 may be executed on any computing device, such as, for example, the computer system described with reference to FIG. 9 and/or processing logic that may comprise hardware (e.g., circuitry, dedicated logic, programmable logic, microcode, etc.), software (e.g., instructions executing on a processing device), or a combination thereof. In some embodiments, method 400 and/or portions of method 400 may be executed on a quantum computing system and/or using quantum computing techniques.

It is to be appreciated that not all steps may be needed to perform the disclosure provided herein. Further, some of the steps may be performed simultaneously, or in a different order than shown in FIG. 4.

At 410, vulnerability scanning system 106 transforms the source code into a source code vector. The source code vector may be based on the content of the source code. In embodiments, the source code vector may be a numeric representation of the source code stored as a vector. The source code vector may include one or more numbers. Vulnerability scanning system 106 may transform the source code into the source code vector using various algorithms, such as Word2Vec, one-hot encoding, and integer encoding. Once the source code is in a numeric format, the source code vector may be applied to a large language model, such as LLM 200, to predict whether the source code includes code that corresponds to a vulnerability.

At 420, vulnerability scanning system 106 determines that the source code includes code corresponding to a vulnerability by applying a large language model to the source code vector. This may occur in the manner described with reference 340 in FIG. 3. In some embodiments, vulnerability scanning system 106 may use vulnerability scanner 112 to make the determination. As an additional layer of security, vulnerability scanning system 106 may use a database, such as vulnerability database 114, to determine whether the source code contains a vulnerability.

At 430, vulnerability scanning system 106 accesses a database, such as vulnerability database 114. As previously explained, vulnerability database 114 may include samples of source code and/or vector representations corresponding to code that corresponds to a vulnerability.

At 440, vulnerability scanning system 106 compares the source code vector to one or more vectors in vulnerability database 114. This comparison may be performed to determine a type of vulnerability. The type of vulnerability may be based on a similarity value when comparing the source code vector to vector entries stored in vulnerability database 114. Since the source code has already been converted to a vector and the entries in vulnerability database 114 are stored as vectors, vulnerability scanning system 106 may compute the similarity by applying one or more similarity algorithms. For example, this may be performed based on a vector similarity search. In some embodiments, vulnerability scanner 112 at vulnerability scanning system 106 may compute the similarity. In some embodiments, vulnerability scanning system 106 may compute the cosine similarity between the source code vector and each entry in vulnerability database 114. In another embodiment, vulnerability scanning system 106 may perform a nearest neighbor search to locate an entry in vulnerability database 114 that is most similar to the source code. The identified vulnerability type may be the entry in vulnerability data database 114 with the highest similarity to the source code vector. In some embodiments, the vulnerability types may include corresponding thresholds. Vulnerability scanning system 106 may determine that a vulnerability probability associated with the vulnerability is greater than a corresponding threshold for the vulnerability type. This determination may be used to identify the vulnerability type of the detected vulnerability.

At 450, vulnerability scanning system 106 determines a vulnerability type. This vulnerability type may correspond to the vulnerability detected in the source code. The vulnerability type determination may be based on the comparison performed at 440 and/or use the techniques described with reference to 440. This may be the vulnerability type used to apply the vulnerability policy at 350.

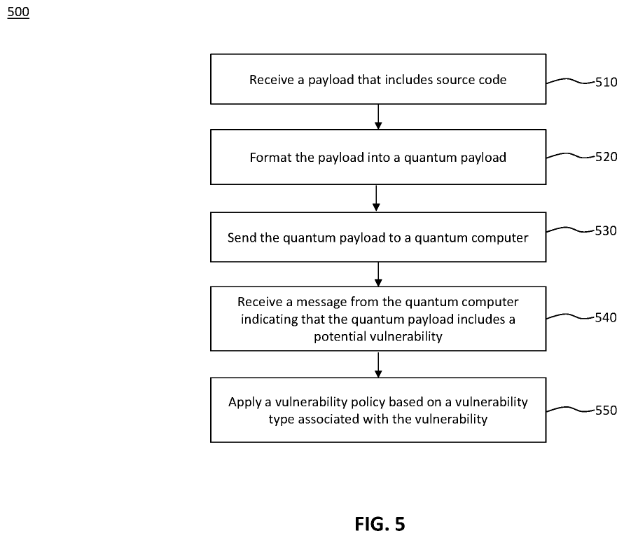

FIG. 5 depicts flowchart illustrating a method 500 for determining whether source code includes a vulnerability using a quantum computing system, according to some embodiments. Method 500 shall be described with reference to FIG. 1B, however, method 500 shall not be limited to that example embodiment.

In an embodiment, vulnerability scanning system 106 may utilize method 500 to identify vulnerabilities in source code. Vulnerability scanning system 106 may use and/or communicate with a quantum computing system, such as quantum system 120, to increase performance and accuracy. The foregoing description will describe an embodiment of the execution of method 500 with respect to vulnerability scanning system 106. While method 500 is described with reference to vulnerability scanning system 106, method 500 may be executed on any computing device, such as, for example, the computer system described with reference to FIG. 9 and/or processing logic that may comprise hardware (e.g., circuitry, dedicated logic, programmable logic, microcode, etc.), software (e.g., instructions executing on a processing device), or a combination thereof. In some embodiments, method 500 may be executed on a quantum computing system, such as quantum system 120.

It is to be appreciated that not all steps may be needed to perform the disclosure provided herein. Further, some of the steps may be performed simultaneously, or in a different order than shown in FIG. 5.

At 510, vulnerability scanning system 106 receives a payload that includes source code. In some embodiments, communications interface 108 at vulnerability scanning system 106 may receive the payload. The payload may contain source code, executable code, or an application. Vulnerability scanning system 106 may receive a packet from client device 102 that includes source code.

At 520, vulnerability scanning system 106 formats the payload into a quantum payload. This may occur in a manner similar to 320 as described with reference to FIG. 3. The quantum payload may be formatted so that it is capable of being received by a quantum system 120. At 530, vulnerability scanning system 106 sends the quantum payload to a quantum computing system. In some embodiments, the quantum payload may be sent over a network such as network 104. In some embodiments, the quantum payload may be placed in a database for retrieval by the quantum computing system. In some embodiments, the quantum computing system may be quantum system 120.

At 540, vulnerability scanning system 106 receives a message from the quantum computing system indicating that the quantum payload includes a potential vulnerability. This may occur when quantum system 120 applies an LLM and/or a GAN to detect a vulnerability in the quantum payload. For example, a discriminator model on the quantum computing system may determine that the source code in the quantum payload contains a potential vulnerability. In some embodiments, this may be performed by a GAN at vulnerability scanner 112 at quantum system 120. For example, vulnerability discriminator 204 may make the determination. As discussed above with respect to FIG. 2, the discriminator model may be optimized to identify and filter source code that contains false positive software vulnerabilities.

In response to determining that the source code contains a potential vulnerability, a large language model on the quantum computing system is applied. In some embodiments, the large language model may be large language model 200 at vulnerability scanner 112 on quantum system 120. The source code may be applied to the large language model. For example, as discussed above with respect to FIG. 2, the large language model (e.g., large language model 200) is trained to identify software vulnerabilities in source code. The large language model may identify more than one vulnerability type in the source code. The large language model may be configured to produce a probability associated with each vulnerability type. The large language model may also be configured to query a database such as vulnerability database 114 to identify similar, known vulnerabilities. Querying the database may be beneficial in a scenario where the probability associated with a given vulnerability type is between two values. The quantum system 120 may transmit a message to vulnerability scanning system 106 indicating that the quantum GAN and/or LLM has detected a potential vulnerability in the source code.

At 550, vulnerability scanning system 106 applies a vulnerability policy based on the vulnerability type. For example, as discussed above in FIG. 3, the vulnerability policy may discard, save, or forward the payload based on the vulnerability types identified. In some embodiments, more than one vulnerability type may be identified. Vulnerability scanning system 106 and/or quantum system 120 may determine the vulnerability type.

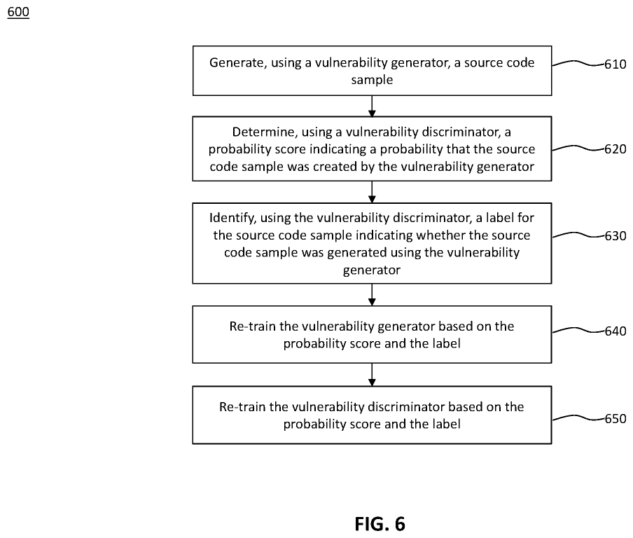

FIG. 6 depicts a flowchart illustrating a method 600 for training a GAN model, according to some embodiments. For example, method 600 may be used by vulnerability scanning system 106 to train vulnerability generator 202 and vulnerability discriminator 204. Method 600 shall be described with reference to FIG. 2, however, method 600 shall not be limited to that example embodiment.

In an embodiment, vulnerability scanning system 106 may utilize method 600 to train a GAN model to identify source code that includes false positive vulnerabilities. Such source code may not need further processing. Method 600 may further be used to generate source code samples for training. The foregoing description will describe an embodiment of the execution of method 600 with respect to vulnerability scanning system 106. While method 600 is described with reference to vulnerability scanning system 106, method 600 may be executed on any computing device, such as, for example, the computer system described with reference to FIG. 9 and/or processing logic that may comprise hardware (e.g., circuitry, dedicated logic, programmable logic, microcode, etc.), software (e.g., instructions executing on a processing device), or a combination thereof. As noted above, vulnerability scanning system 106 may be implemented on a quantum computing system. Thus, in some embodiments, method 600 may be executed on a quantum computing system.

It is to be appreciated that not all steps may be needed to perform the disclosure provided herein. Further, some of the steps may be performed simultaneously, or in a different order than shown in FIG. 6.

At 610, vulnerability scanning system 106 generates, using vulnerability generator 202, a source code sample. The source code sample may include a false positive vulnerability. For example, vulnerability generator 202 generates a false positive source code sample. A false positive source code sample may be one that appears to contain a vulnerability but does not. For example, a function that leaves the program open to a SQL injection may be commented out. Vulnerability generator 202 may generate the sample in response to a prompt. For example, vulnerability generator 202 may use natural language processing to receive, interpret, and/or execute requests to generate certain source code examples. As one example, vulnerability generator 202 may receive a request stating, “Create a Python function that reads input from a user that is susceptible to a SQL injection attack.”

Vulnerability generator 202 may generate a false positive source code sample in response to the prompt. As stated above, vulnerability generator 202 may be optimized to generate source code that appears authentic (e.g., as if they came from client device 102). Vulnerability generator 202 may be initialized with random values and/or may be re-trained from this state.

At 620, vulnerability scanning system 106 determines, using vulnerability discriminator 204, a probability score indicating a probability that the source code sample was created by vulnerability generator 202. The probability score may be based on a set of weights associated with each class and/or indicate whether the message originated from vulnerability generator 202 or not. The weights may correspond to one or more source code features. Vulnerability scanning system 106 may also compare the probability score to a threshold to determine whether the source code was created by vulnerability generator 202. For example, if the probability score is greater than 50%, vulnerability discriminator 204 may apply a label that the source code came from vulnerability generator 202. In some embodiments, the threshold value may be updated.

At 630, vulnerability scanning system 106 identifies, using vulnerability discriminator 204, a label for the source code sample indicating whether the source code sample was generated by vulnerability generator 202. In some embodiments, this may be performed by providing a label associated with the source code example to vulnerability discriminator 204. The label may designate whether the source code was created by vulnerability generator 202. Vulnerability discriminator 204 can compare the label to its own determination to discern whether it was correct. In some embodiments, labels corresponding to source code created by vulnerability generator 202 may be “0,” “false positive,” or “sample.” In some embodiments, source code not created by vulnerability generator 202 may be labelled “1,” “captured,” or “true.”

At 640, vulnerability scanning system 106 re-trains vulnerability generator 202 based on the probability score and the label. Back propagation may be used to update vulnerability generator 202. For example, vulnerability generator 202 may maintain a set of weights representing message features. Vulnerability generator 202 may update the set of weights based on vulnerability discriminator's 204 determination and the generated source code's features. In some embodiments, vulnerability generator 202 may be re-trained after generating and receiving responses from vulnerability discriminator 204 for a certain number of source code examples. For example, at the beginning of training, vulnerability generator 202 may create source code examples with syntax errors such as having unmatched parenthesis or mixing variable types. Vulnerability discriminator 204 may detect these errors and identify that the code was likely created by vulnerability generator 202. In response, vulnerability generator 202 may be updated to remove these syntax errors to make it more difficult for vulnerability discriminator 204 to discern where the code came from.

At 650, vulnerability scanning system 106 re-trains vulnerability discriminator 204 based on the probability score and the label. Back propagation may be used to update vulnerability discriminator 204. In response to each source code example and its corresponding label, vulnerability discriminator 204 may update the weights for each class. In some embodiments, if vulnerability discriminator 204 correctly identified source code as coming from vulnerability generator 202, vulnerability discriminator 204 may adjust the weights associated with the features of the source code. In some embodiments, vulnerability discriminator 204 may be re-trained after analyzing a certain number of source code examples.

As an example, vulnerability generator 202 may create a false positive source code example containing a function that appears to include a vulnerability, but does not. Vulnerability discriminator 204 may analyze the source code and generate a probability score of 60% that is greater than the 50% threshold. Vulnerability discriminator 204 may then identify the source code's label (e.g., truth data). Vulnerability discriminator 204 can use this generated source code and its label to re-train. For example, vulnerability discriminator 204 may use the source code's features to adjust the weights corresponding to the source code features. Vulnerability generator 202 may also be re-trained as a result of this process.

As another example, vulnerability discriminator 204 may receive a source code example that was not generated by vulnerability generator 202. These source code examples may be considered captured and/or live source code examples. Captured source code examples may have been generated by client device 104 and/or saved for later use once it reached network 104. The captured source code may be vulnerable to one or more attacks, such as a SQL injection or command injection. In this example, vulnerability discriminator 204 may analyze the source code and predict with 70% confidence that the source code came from vulnerability generator 202. Since this is greater than the 50% threshold, vulnerability discriminator 204 would apply a label designating that the source code came from vulnerability generator 202. Vulnerability discriminator 204 may then receive the source code's label that it was captured source code, and determine that its prediction was incorrect since it predicted that the source code was created by vulnerability generator 202. Vulnerability discriminator 204 may then be re-trained based on this determination. As stated above, the training process may involve updating a set of feature weights maintained by vulnerability discriminator 204. Since, in this example, vulnerability discriminator 204 was incorrect, features associated with the source code would be adjusted accordingly.

By applying method 600, vulnerability generator 202 may be trained to produce increasingly realistic source code samples. Similarly, vulnerability discriminator 204 may be trained to more accurately detect where each sample originated. This has many technological benefits. First, vulnerability generator 202 may be used to create realistic training data sets that may be used to train both vulnerability discriminator 204 but also LLM 200. This is helpful because oftentimes, training data is built from actual data that has been saved for future use. A training data set may be constructed from actual source code samples sent from client device 102. However, sampling actual payloads may not produce an equal distribution of vulnerability types. As a result, vulnerability scanner 112 would likely have improved accuracy with respect to the vulnerability types it sees more often. To improve vulnerability scanner 112's accuracy, vulnerability generator 202 may be leveraged to generate realistic source code samples that may ultimately be used to train vulnerability scanner 112 to improve its accuracy and make it more robust.

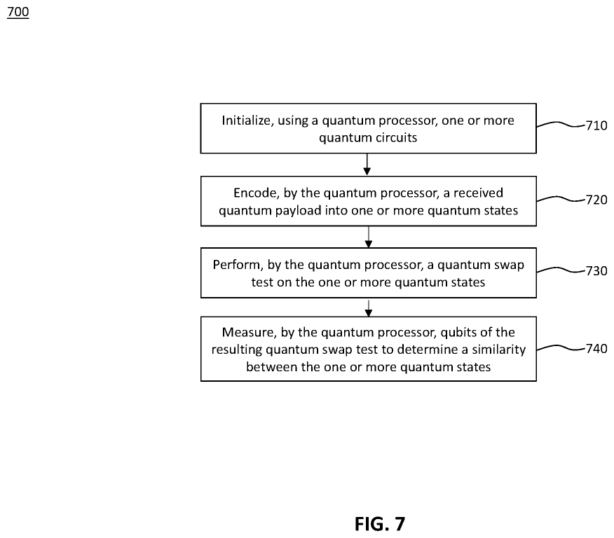

FIG. 7 depicts a flowchart illustrating a method 700 for applying a quantum analysis to a payload, according to some embodiments. Method 700 shall be described with reference to FIG. 1; however, method 700 is not limited to that example embodiment.

In an embodiment, vulnerability scanning system 106 may utilize method 700 to initialize a quantum system and/or to determine whether a payload includes a vulnerability. In some embodiments, vulnerability scanning system 106 may implement a quantum computer and/or quantum computing techniques. For example, the quantum computer may be part of an enterprise computing system implementing vulnerability scanning system 106. The foregoing description will describe an embodiment of the execution of method 700 with respect vulnerability scanning system 106 and/or quantum system 120. While method 700 is described with reference to vulnerability scanning system 106 and/or quantum system 120, method 700 may be executed on any quantum computing device, such as, processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 7.

At 710, vulnerability scanning system 106 may initialize one or more quantum circuits. Vulnerability scanning system 106 may initialize the one or more quantum circuits using a quantum processor. These components may be implemented in vulnerability scanning system 106 and/or in quantum system 120. The one or more quantum circuits may include one or more quantum gates. At 720, received payloads may be encoded into one or more quantum states. In some embodiments, the payloads may be encoded using amplitude encoding. This technique associates each quantum state with a given amplitude. As explained herein, the payloads may include source code.

At 730, a swap test may be performed on the one or more quantum states. This may also be referred to as a SWAP test. The swap test may be used to check whether two quantum states differ and/or a magnitude of difference. In some embodiments, the swap test may receive two input states. The input states may be represented by qubits. This swap test may determine whether qubits corresponding to the source code in the payload are similar to qubits corresponding to source code vulnerability examples. For example, a higher degree of similarity may indicate that the payload includes a vulnerability.

At 740, the qubit results of the swap test may be measured to determine a similarity between the one or more quantum states. For example, the measurement may produce a zero if the states are orthogonal, and a one if they are equal. As previously stated, the one or more quantum states may be represented by qubits. This comparison may be used to determine whether the payload includes a vulnerability.

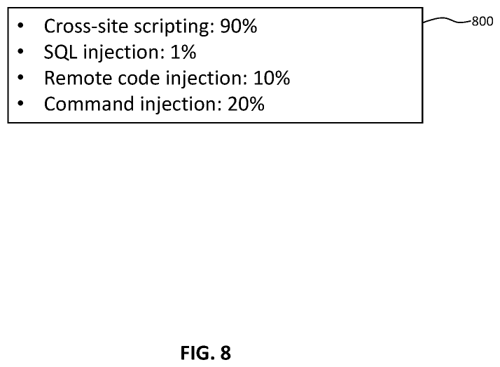

FIG. 8 depicts an example vulnerability score report 800, according to some embodiments. Vulnerability score report 800 may be generated by vulnerability scanner 112. Vulnerability scanner 112 may generate a graphical user interface displaying metrics and/or data as reflected in vulnerability score report 800. Vulnerability scanner 112 may transmit this graphical user interface data to client device 102 for rendering and/or display.

In some embodiments, vulnerability score report 800 may list each vulnerability type and LLM 200's corresponding predicted probability for that type. In some embodiments, vulnerability score report 800 may list each vulnerability type in vulnerability database 114 to which the source code was compared, and the corresponding probability that the source code included the corresponding vulnerability type. The probability may be based on the similarity between the source code vector and the stored vector representation of the vulnerability type. For example, the source code may have been compared to source code samples including four vulnerability types: (1) cross-site scripting; (2) SQL injection; (3) remote code injection; and (4) command injection.

Each vulnerability type may have a corresponding probability based on the similarity to the source code vector. The probability may be denoted as a percentage (e.g., 90%). In some embodiments, vulnerability scanner 112 may be configured to list only certain vulnerability types, or only vulnerability types with a corresponding probability score greater than a certain percentage. For example, vulnerability types with probability scores greater than 50% may be listed on vulnerability score report 800. This may be useful in a situation where there is uncertainty as to whether the payload contains a vulnerability, and so the payload along with vulnerability score report 800 may be saved for later inspection.

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 903, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (e.g., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments may operate with software, hardware, and/or operating system implementations other than those described herein.

It is to be appreciated that the Detailed Description section, and not any other section, is intended to be used to interpret the claims. Other sections may set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for source code vulnerability detection, comprising:
receiving source code;
generating quantum source code by transforming the source code into a quantum computing data format;
determining that the source code includes a potential vulnerability by applying a quantum generative adversarial network (QGAN) model to the quantum source code;
in response to determining that the source code includes the potential vulnerability, determining that the source code includes code corresponding to a vulnerability by applying a large language model to the source code; and
in response to determining that the source code includes code corresponding to the vulnerability, applying a vulnerability policy to the source code based on a vulnerability type associated with the vulnerability.

2. The computer implemented method of claim 1, wherein determining that the source code includes code corresponding to a vulnerability further comprises:
transforming the source code into a source code vector, wherein the source code vector is based on content of the source code;
comparing the source code vector to one or more vectors stored in a vulnerability database, wherein each of the one or more stored vectors corresponds to a type of vulnerability; and
determining, based on the comparing, the vulnerability type.

3. The computer implemented method of claim 1, further comprising:
training the large language model using a vulnerability database as training data, wherein the vulnerability database comprises one or more stored vectors, wherein each of the one or more stored vectors corresponds to a type of vulnerability.

4. The computer implemented method of claim 1, wherein the QGAN comprises a generator model and a discriminator model, the method further comprising:
generating, by the generator model, a source code sample;
determining, by the discriminator model, a probability score indicating a probability that the source code sample was created by the generator model;
identifying, by the discriminator model, a label for the source code sample, wherein the label indicates whether the source code sample was generated by the generator model;
re-training the generator model based on the probability score and the label; and
re-training the discriminator model based on the probability score and the label.

5. The computer implemented method of claim 1, wherein the vulnerability is one of cross-site scripting, structured query language (SQL) injection, remote code execution, or command injection.

6. The computer implemented method of claim 1, wherein determining that the source code includes code corresponding to a vulnerability further comprises:
generating a vulnerability score report comprising one or more vulnerability types and one or more corresponding vulnerability probabilities, wherein each of the one or more vulnerability probabilities represent the probability that the source code includes a vulnerability of the corresponding vulnerability type.

7. The computer implemented method of claim 1, wherein the vulnerability type has a corresponding threshold, and wherein applying the vulnerability policy further comprises:
determining that a vulnerability probability associated with the vulnerability is greater than the corresponding threshold of the vulnerability type.

8. The computer implemented method of claim 1, wherein the vulnerability policy comprises discarding the source code, storing the source code, or forwarding the source code to a destination.

9. A system, comprising:
a memory; and
at least one processor coupled to the memory and configured to:
receive source code;
generate quantum source code by transforming the source code into a quantum computing data format;
determine that the source code includes a potential vulnerability by applying a quantum generative adversarial network (QGAN) model to the quantum source code;
in response to determining that the source code includes the potential vulnerability, determine that the source code includes code corresponding to a vulnerability by applying a large language model to the source code; and
in response to determining that the source code includes code corresponding to the vulnerability, applying a vulnerability policy to the source code based on a vulnerability type associated with the vulnerability

10. The system of claim 9, wherein determine that the source code includes code corresponding to a vulnerability, the at least one processor is further configured to:
transform the source code into a source code vector, wherein the source code vector is based on content of the source code; and
compare the source code vector to a vector stored in a vulnerability database, wherein the stored vector corresponds to a type of vulnerability; and
determine, based on the comparing, the vulnerability type.

11. The system of claim 9, wherein the QGAN further comprises a generator model and a discriminator model, and wherein the at least one processor is further configured to:
generate, using the generator model, a source code sample;
determine, using the discriminator model, a probability score indicating a probability that the source code sample was created by the generator model;
identify, using the discriminator model, a label for the source code sample, wherein the label indicates whether the source code sample was generated by the generator model;
re-train the generator model based on the probability score and the label; and
re-train the discriminator model based on the probability score and the label.

12. The system of claim 9, wherein the vulnerability is one of cross-site scripting, structured query language (SQL) injection, remote code execution, or command injection.

13. The system of claim 9, wherein to determine that the source code includes code corresponding to a vulnerability, the at least one processor is further configured to:
generate a vulnerability score report comprising one or more vulnerability types and one or more corresponding vulnerability probabilities, wherein each of the one or more vulnerability probabilities represent the probability that the source code includes a vulnerability of the corresponding vulnerability type.

14. The system of claim 9, wherein the vulnerability type has a corresponding threshold, and wherein to apply the vulnerability policy, the at least one processor is further configured to:
determine that a vulnerability probability associated with the vulnerability is greater than the corresponding threshold of the vulnerability type.

15. The system of claim 9, wherein the policy comprises discarding the source code, storing the source code, or forwarding the source code to a destination.

16. A non-transitory computer-readable device having instructions stored thereon that, when executed by at least one computing device, cause the at least one computing device to perform operations comprising:
receiving source code;
generating quantum source code by transforming the source code into a quantum computing data format;
determining that the source code includes a potential vulnerability by applying a quantum generative adversarial network (QGAN) model to the quantum source code;
in response to determining that the source code includes the potential vulnerability, determining that the source code includes code corresponding to a vulnerability by applying a large language model to the source code; and
in response to determining that the source code includes code corresponding to the vulnerability, applying a vulnerability policy to the source code based on a vulnerability type associated with the vulnerability.

17. The non-transitory computer-readable device of claim 16, wherein determining that the source code includes code corresponding to a vulnerability further comprises:
transforming the source code into a source code vector, wherein the source code vector is based on content of the source code;
comparing the source code vector to one or more vectors stored in a vulnerability database, wherein each of the one or more stored vectors corresponds to a type of vulnerability; and
determining, based on the comparing, the vulnerability type.

18. The non-transitory computer-readable device of claim 16, wherein the vulnerability is one of cross-site scripting, structured query language (SQL) injection, remote code execution, or command injection.

19. The non-transitory computer-readable device of claim 16, wherein the vulnerability type has a corresponding threshold, and wherein applying the vulnerability policy further comprises:
determining that a vulnerability probability associated with the vulnerability is greater than the corresponding threshold of the vulnerability type.

20. The non-transitory computer-readable device of claim 16, wherein the QGAN comprises a generator model and a discriminator model, and wherein the operations further comprise:
generating, by the generator model, a source code sample;
determining, by the discriminator model, a probability score indicating a probability that the source code sample was created by the generator model;
identifying, by the discriminator model, a label for the source code sample, wherein the label indicates whether the source code sample was generated by the generator model;
re-training the generator model based on the probability score and the label; and
re-training the discriminator model based on the probability score and the label.
